(19) United States
(12) Patent Application Publication
(10) Pub. No.: US 2025/0378331 A1
(43) Pub. Date: Dec. 11, 2025

(54) DATA PROCESSING METHOD AND APPARATUS, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventor: Jing GONG, Shenzhen (CN)

(21) Appl. No.: 19/309,132

(22) Filed: Aug. 25, 2025

Related U.S. Application Data
(63) Continuation of application No. PCT/CN2023/130346, filed on Nov. 8, 2023.

(30) Foreign Application Priority Data
Jun. 19, 2023 (CN) 202310733698.7

(51) Int. Cl. G06N 3/08; G06N 3/0464; G06N 3/0475

(52) U.S. Cl. CPC G06N 3/08; G06N 3/0464; G06N 3/0475

(57) ABSTRACT

A data processing method includes: obtaining an initial generative model, and determining a target operator to be quantized from the initial generative model; determining, based on a category and a quantity of the target operator, a preset quantization policy for performing quantization processing on the target operator; performing the quantization processing on the target operator by using the preset quantization policy to obtain a generative model to be trained; and training the generative model by using a training input object to obtain a trained generative model.

### CROSS-REFERENCES TO RELATED APPLICATIONS

This application is a continuation of PCT Application No. PCT/CN2023/130346, filed on Nov. 8, 2023, which claims priority to Chinese Patent Application No. 202310733698.7 filed on Jun. 19, 2023, the entire contents of all of which are incorporated herein by reference.

### FIELD OF THE TECHNOLOGY

The present disclosure relates to the field of computers, and in particular, to a data processing method and apparatus, an electronic device, a computer-readable storage medium, and a computer program product.

### BACKGROUND OF THE DISCLOSURE

A generative model is a model that may generate a new sample data set from a random vector. It is an important model in the field of machine learning.

In the process of training generative models, operation personnel usually needs to adjust the models one by one, which is time-consuming and inefficient.

### SUMMARY

Embodiments of the present disclosure provide a data processing method and apparatus, an electronic device, a computer-readable storage medium, and a computer program product, to reduce training duration of a generative model and improve training efficiency.

The embodiments of the present disclosure provide a data processing method, applied to an electronic device, the method including: obtaining an initial generative model, and determining a target operator to be quantized from the initial generative model; determining, based on a category and a quantity of the target operator, a preset quantization policy for performing quantization processing on the target operator; performing the quantization processing on the target operator by using the preset quantization policy to obtain a generative model to be trained; and training the generative model by using a training input object to obtain a trained generative model.

The embodiments of the present disclosure further provide a data processing apparatus, including: a model obtaining unit, configured to obtain an initial generative model, and determine a target operator to be quantized from the initial generative model; a policy determining unit, configured to determine, based on a category and a quantity of the target operator, a preset quantization policy for performing quantization processing on the target operator; a quantization processing unit, configured to perform the quantization processing on the target operator by using the preset quantization policy to obtain a generative model to be trained; and a model training unit, configured to train the generative model by using a training input object to obtain a trained generative model.

The embodiments of the present disclosure provide an electronic device, including a processor and a memory, the memory storing a plurality of instructions, and the processor loading the instructions from the memory, to execute operations in the data processing method according to the embodiments of the present disclosure.

The embodiments of the present disclosure provide a non-transitory computer-readable storage medium, having a plurality of instructions stored therein, the instructions being loaded by a processor to execute operations of the data processing method according to the embodiments of the present disclosure.

In the data processing method provided in the embodiments of the present disclosure, an initial generative model may be first obtained, and then a target operator is searched for in the initial generative model. After the target operator is found, quantization processing may be performed on the target operator based on a category of the target operator by using a preset quantization policy, to obtain a generative model to be trained. Subsequently, the to-be-trained generative model may be trained by using a training input object, to obtain a trained generative model.

In the embodiments of the present disclosure, the target operator is one operator or a combination of a plurality of operators arranged in a set order. Therefore, the initial generative model may be first obtained, and the target operator is searched for in the initial generative model. Then, the quantization processing is performed on the target operator based on a preset quantization policy corresponding to the category of the target operator, to obtain a quantized initial generative model. Subsequently, the quantized initial generative model is trained, to obtain a trained generative model. By searching and performing quantization processing on the target operator, the model structure of the initial generative model can be simplified, so that the training efficiency of the model can be improved. In addition, the processing operations of searching for a preset target operator and performing quantization processing on the target operator based on a corresponding preset quantization policy can be used for training of the generative model in batches, so that the problem of time-consuming and inefficient generative model training in the related art can be improved.

### BRIEF DESCRIPTION OF THE DRAWINGS

FIG. 1a is a schematic diagram of a usage scenario of a data processing method according to an embodiment of the present disclosure.

FIG. 1b is a schematic flowchart of a data processing method according to an embodiment of the present disclosure.

FIG. 1c is a schematic structural block diagram of an operator replacement processing process.

FIG. 1d is a schematic structural block diagram of performing operator combination insertion processing and operator fusion processing on Conv.

FIG. 1e is a schematic structural block diagram of performing operator combination insertion processing and operator fusion processing on Conv+BN+ReLU.

FIG. 1f is a schematic structural block diagram of performing operator combination insertion processing and operator fusion processing on Conv+BN+Add.

FIG. 1g is a schematic structural diagram of a model structure part whose data precision needs to be maintained.

FIG. 2 is a schematic flowchart of a data processing method according to another embodiment of the present disclosure.

FIG. 3 is a schematic structural diagram of a data processing apparatus according to an embodiment of the present disclosure.

FIG. 4 is a schematic structural diagram of an electronic device according to an embodiment of the present disclosure.

### DESCRIPTION OF EMBODIMENTS

Technical solutions in embodiments of the present disclosure are clearly and completely described below with reference to accompanying drawings in the embodiments of the present disclosure. Apparently, the described embodiments are merely some rather than all of the embodiments of the present disclosure. All other embodiments obtained by a person skilled in the art based on the embodiments of the present disclosure without creative efforts shall fall within the protection scope of the present disclosure.

Terms involved in the present disclosure are explained below.
1) Generative model: It is a model that generates a new sample data set from a random vector.
2) Operator: A deep learning algorithm is composed of computing units, which may also be referred to as operators. In a network model, an operator corresponds to computational logic in a layer. For example, a convolution layer is a convolution operator, and a rectified linear unit (ReLU) is an operator used as an activation function in the network model.
3) Quantization processing, which may also be referred to as a quantization operation, refers to performing discretization processing on an input quantity of an operator, to adapt the input quantity to low-bit representation and storage.
4) A quantized operator is an operator capable of performing quantization processing.
5) Dequantization processing, which may also be referred to as a dequantization operation, refers to restoring data having been subjected to a quantization operation to a high-precision floating-point number or integer. The dequantization operation is an inverse operation of a quantization operation, and can recover an information loss caused by quantization.
6) A dequantized operator is an operator capable of performing a dequantization operation.

The embodiments of the present disclosure provide a data processing method and apparatus, an electronic device, a computer-readable storage medium, and a computer program product.

The data processing apparatus may be integrated in an electronic device. The electronic device may be a device such as a terminal or a server. The terminal may be a device such as a mobile phone, a tablet computer, a smart Bluetooth device, a notebook computer, or a personal computer (PC), or may be an intelligent device having a computing function. The server may be a single server, or may be a server cluster including a plurality of servers.

In some embodiments, the data processing apparatus may also be integrated in a plurality of electronic devices. For example, the data processing apparatus may be integrated in a plurality of servers, and the data processing method of the present disclosure is implemented by the plurality of servers.

In some embodiments, the server may also be implemented in a form of a terminal.

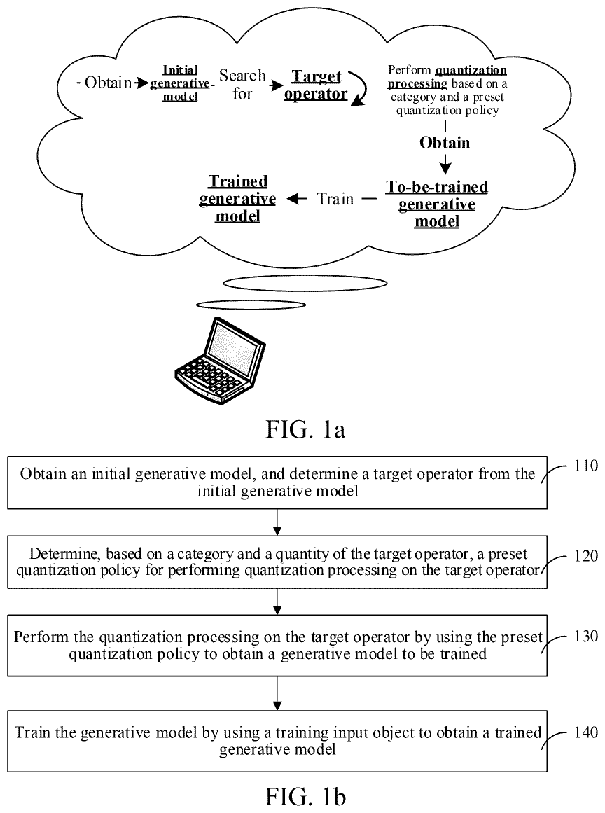

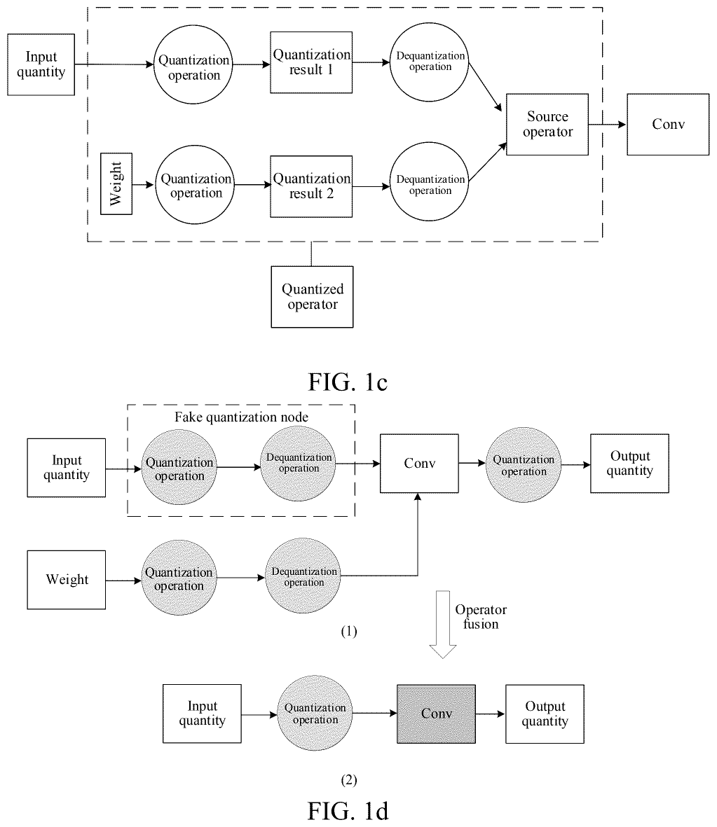

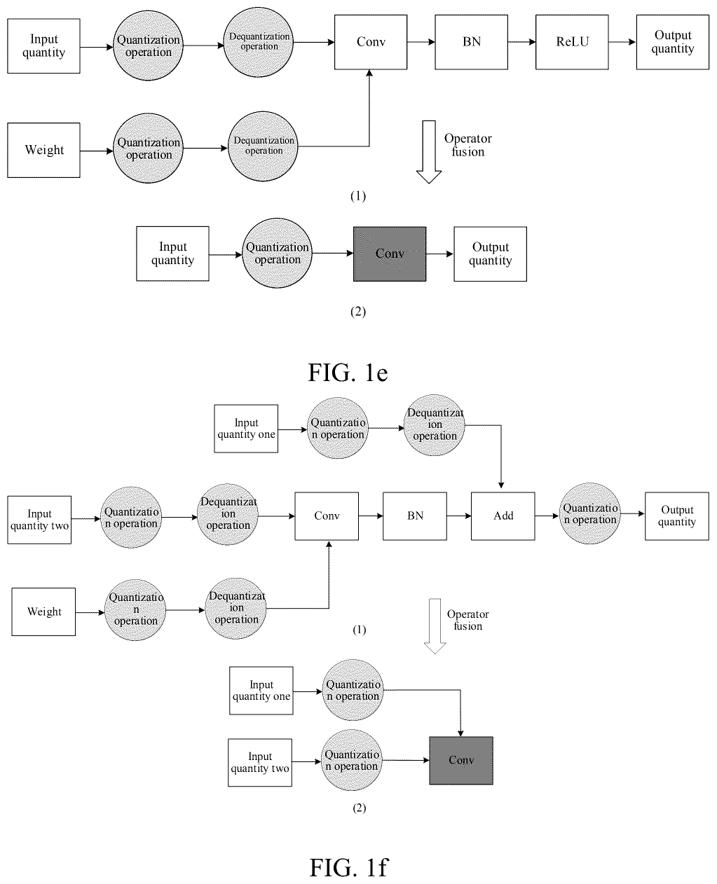

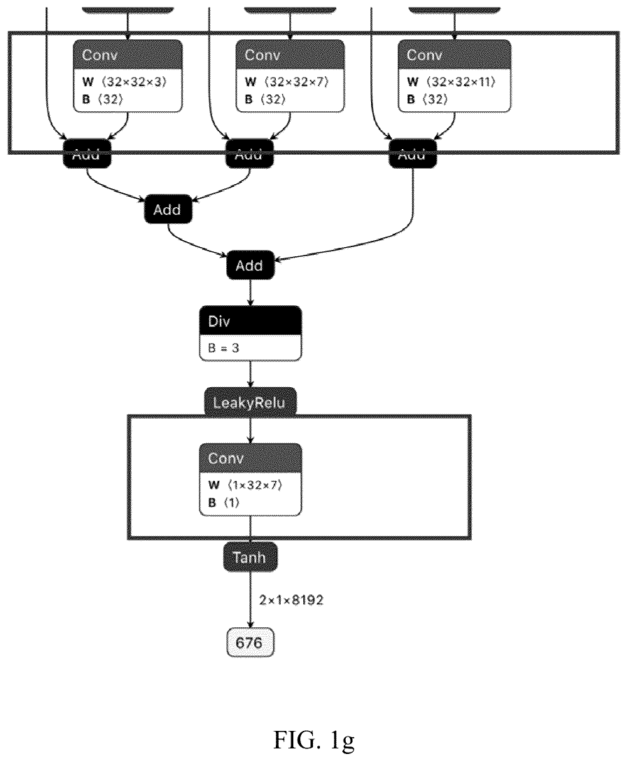

Referring to FIG. 1a, a data processing method provided in an embodiment of the present disclosure includes: obtaining an initial generative model; determining a target operator from the initial generative model; performing quantization processing on the target operator by using a preset quantization policy based on a category and a quantity of the target operator, to obtain a generative model to be trained; and training the generative model by using a training input object to obtain a trained generative model.

In the foregoing method, the processing operations of determining a preset target operator and performing quantization processing on the target operator based on a corresponding preset quantization policy can be used for training of the generative model in batches, so that the problem of time-consuming and inefficient generative model training in the related art can be resolved.

In the embodiments of the present disclosure, when the embodiments of the present disclosure are applied to a specific product or technology, data related to user information, such as collection, use, and processing of the related data need to comply with the laws, regulations, and standards of related countries and regions.

A data processing method, a data processing apparatus, and an electronic device provided in the embodiments of the present disclosure will be respectively described below. Sequence numbers of the following embodiments are not intended to be construed as a preferred order of the embodiments.

In the embodiments of the present disclosure, a data processing method is provided. As shown in FIG. 1b, the data processing method is applied to an electronic device. An implementation process of the method may include operation 110 to operation 140 as follows.

Operation 110: Obtain an initial generative model, and determine a target operator to be quantized from the initial generative model.

The initial generative model is a model that can generate a new sample data set from a random vector. In some embodiments, the initial generative model may be a non-probabilistic generative model that can learn and generate outputs through a neural network or other means, for example, may be a model such as an autoencoder, a generative adversarial network (GAN), or a pixel convolutional neural network (PixelCNN). The to-be-quantized target operator may be preset. The target operator may be one operator, or may be an operator combination formed by a plurality of operators. When the target operator is an operator combination formed by a plurality of operators, the plurality of operators may be arranged in a particular order to form the target operator.

For example, the target operator is one operator, such as a convolution operator Conv, a deconvolution operator Deconv, or a linear transformation operator (Linear). The target operator may also be an operator combination formed by a plurality of operators that are arranged in a fixed order, for example, may be an operator combination formed by a convolution operator Conv, a batch normalization operator (BN), and an activation function ReLU: Conv+BN+ReLU, or an operator combination formed by a convolution operator Conv, a batch normalization operator (BN), and an addition operator (Add): Conv+BN+Add. A specific combination form of the target operator is not to be construed as a limitation to the present disclosure.

Operation 120: Determine, based on a category and a quantity of the target operator, a preset quantization policy for performing quantization processing on the target operator.

The preset quantization policy is a policy that is preset and used for quantizing the target operator. The preset quantization policy may be a replacement policy or an insertion policy. Each target operator corresponds to a preset quantization policy, and the preset quantization policy corresponding to a target operator may be determined by the category and the quantity of the target operator. In some embodiments, when the quantity of the target operator is one, it is determined that the preset quantization policy is to perform operator replacement processing on the target operator; or when the quantity of the target operators is at least two or when the quantity of the target operator is one and the category of the target operator is a convolution operator, it is determined that the preset quantization policy is to insert a quantized operator combination into a target location, where the quantized operator combination is applied in the quantization processing, and the quantized operator combination includes a quantized operator and a dequantized operator.

In some embodiments, if a target operator can perform both an operator replacement processing process and a process of inserting a quantized operator combination into a target location, a quantization processing process that needs to be performed by the target operator may be determined based on priorities of the processes. For example, a priority of the operator replacement processing process may be set to be higher than a priority of the process of inserting a quantized operator combination into a target location. Therefore, if a target operator can perform both an operator replacement processing process and a process of inserting a quantized operator combination into a target location (such as a convolution operator Conv), the operator replacement processing process may be performed based on the priorities. If the operator replacement processing process cannot be implemented due to a fault, the process of inserting a quantized operator combination into a target location is performed. If the operator replacement processing process is successfully performed, the process of inserting a quantized operator combination into a target location does not need to be performed.

In the foregoing implementation, if a target operator can perform both an operator replacement processing process and a process of inserting a quantized operator combination into a target location, the operator replacement processing process may be performed on the target operator based on preset priorities. If the operator replacement processing process is successfully performed, the process of inserting a quantized operator combination into a target location does not need to be performed. If the operator replacement processing process cannot be implemented due to a fault, the process of inserting a quantized operator combination into a target location is performed. Compared with the process of inserting a quantized operator combination into a target location, the operator replacement processing process can reduce the computational load of the model. Therefore, setting the priority of the operator replacement processing process to be higher than the priority of the process of inserting a quantized operator combination into a target location is more conducive to improving processing efficiency of the model.

Operation 130: Perform the quantization processing on the target operator by using the preset quantization policy to obtain a generative model to be trained.

In an implementation, when the quantity of the target operator is one, i.e., the target operator is a single operator, the quantization processing is performed on the target operator by using the preset quantization policy, i.e., operator replacement processing is performed on the target operator, to obtain the to-be-trained generative model. Performing the operator replacement processing on the target operator includes: obtaining an operator combination of an input quantity direction of the target operator, and determining a quantized operator; and then, replacing the operator combination by using the quantized operator, to obtain the to-be-trained generative model. A value of the quantized operator may be determined by using an input quantity and a weight of the target operator. For example, the value of the quantized operator may be a product of the input quantity and the weight, or may be an integer multiple of a product of the input quantity and the weight.

In some embodiments, the category of the target operator may be: a convolution operator Conv, a deconvolution operator Deconv, and a linear transformation operator Linear. For ease of description, the convolution operator Conv is used as an example for description.

Referring to FIG. 1c, after the convolution operator Conv is found, an operator combination of the input quantity direction of the convolution operator Conv, i.e., the operator combination encircled in a dashed-line box shown in FIG. 1c, can be obtained. Then, the operator combination encircled in the dashed-line box shown in FIG. 1c is replaced with a quantized operator (Quant OP). A value of the Quant OP is related to an input quantity and a weight of a to-be-calculated operator encircled in a dashed-line box shown in FIG. 1c. In an implementation, the Quant OP may be a product of the input quantity of the to-be-calculated operator and the weight of the to-be-calculated operator. In another implementation, the Quant OP may be an integer multiple of the product of the input quantity of the to-be-calculated operator and the weight of the to-be-calculated operator. For example, a value of the integer may be 3, or may be other values such as 2. A specific value of the integer is not to be construed as a limitation to the present disclosure.

In the foregoing implementation, the original target operator is replaced with the quantized operator, so that the operator structure of the model can be simplified, thereby improving the operational speed of the model.

In some embodiments, the operator combination encircled in the dashed-line box shown in FIG. 1c may include a quantized operator that performs a quantization operation and a dequantized operator that performs a dequantization operation, or may not include a quantized operator or a dequantized operator. The quantized operator and the dequantized operator are shown in FIG. 1c to describe that the convolution operator Conv can also perform quantization processing by inserting a quantized operator combination into a target location.

In an implementation, when the quantity of the target operator is one and the target operator is the convolution operator, i.e., the target operator is a single convolution operator, the preset quantization policy may be to insert a quantized operator combination into a target location, where the target location is a location between the input quantity and the convolution operator. In other words, when the quantity of the target operator is one and the category of the target operator is a convolution operator, an implementation of operation 130 includes: inserting a quantized operator combination into a location between an input quantity and the convolution operator; adding, to the initial generative model, a quantized operator combination configured to quantize a weight of the convolution operator, and obtaining the to- be-trained generative model when an output location of the convolution operator is connected to a batch normalization operator; and inserting the quantized operator into the output location of the convolution operator to obtain the to-be-trained generative model, when the output location of the convolution operator is not connected to a batch normalization operator.

Referring to (1) in FIG. 1d, if the output location of the convolution operator Conv is not connected to a batch normalization operator, the quantized operator is inserted into the output location of the convolution operator.

In another implementation, when the quantity of the target operators is at least two and the target operators include a convolution operator, the preset quantization policy is also to insert a quantized operator combination into a target location, where the target location may be a location between the input quantity and the convolution operator. In this case, performing the quantization processing on the target operators by using the preset quantization policy is inserting the quantized operator combination into the location between the input quantity and the convolution operator, where the quantized operator combination is applied in the quantization processing, and the quantized operator combination includes a quantized operator and a dequantized operator; adding, to the initial generative model, a quantized operator combination configured to quantize a weight of the convolution operator; and skipping quantization on an output of the convolution operator, when the target operators include a batch normalization operator and an activation function that are sequentially connected to the output location of the convolution operator. In this case, the to-be-trained generative model is obtained.

In some embodiments, when the quantity of the target operators is at least two, the target operators may be: an operator combination formed by a convolution operator Conv, a batch normalization operator (BN), and an activation function ReLU: Conv+BN+ReLU; or, the target operator may be: an operator combination formed by a convolution operator Conv, a batch normalization operator (BN), and an addition operator (Add): Conv+BN+Add. Each target operator has a corresponding target location.

The quantized operator combination includes a quantized operator and a dequantized operator. After at least one target location corresponding to each target operator is found, a corresponding quantized operator combination may be inserted into each of the at least one target location, thereby implementing quantization processing for the target operator.

In the foregoing implementation, when the target operator is a single operator, the operator replacement processing may be performed on the target operator; or when the quantity of the target operators is at least two, i.e., the target operator is a multi-operator combination, or the target operator is a single convolution operator, the quantized operator combination may be inserted into the target location. The foregoing two processing manners cover more operators, thereby expanding the application range of the solution.

In the foregoing implementation, by performing the quantization processing on the target operator, the operator structure of the target operator can be simplified or the value type of the input quantity can be changed, thereby improving the operational speed of the to-be- trained generative model and reducing the computational load of training of the to-be-trained generative model.

When the quantity of the target operators is at least two or when the quantity of the target operator is one and the category of the target operator is a convolution operator, the quantized operator combination used for quantizing the weight of the convolution operator further needs to be added to the initial generative model, to obtain the to-be-trained generative model.

Referring to (1) in FIG. 1d, (1) in FIG. 1e, and (1) in FIG. 1f, if the target operator includes a convolution operator Conv, a quantized operator combination, which includes a quantized operator and a dequantized operator, may be inserted into the location between the input quantity and the convolution operator. In addition, a quantized operator combination, which includes a quantized operator and a dequantized operator, used for quantizing the weight of the convolution operator is also added to the initial generative model.

In another implementation, when the quantity of target operators is at least two and the target operators include a convolution operator, quantization on the output of the convolution operator is skipped, if the target operators further include a batch normalization operator and an activation function that are sequentially connected to an output location of the convolution operator.

Referring to (1) in FIG. 1e, if a combination of a batch normalization operator BN and an activation function ReLU is sequentially connected to the output location of the convolution operator, quantization is no longer performed on the output of the convolution operator.

In still another implementation, when the quantity of the target operators is at least two, the target operators include a convolution operator, the target operators include a batch normalization operator that is sequentially connected to the output location of the convolution operator, and the batch normalization operator is further connected to a first input branch of the addition operator, quantization on an output of the convolution operator is skipped, the quantized operator combination is inserted into a second input branch of the addition operator, and the quantized operator is inserted into an output location of the addition operator.

Referring to (1) in FIG. 1f, if the output location of the target operator is connected to a batch normalization operator BN and the batch normalization operator BN is further connected to a first input branch of an addition operator Add, quantization on the output of the convolution operator is skipped, a quantized operator combination including a quantized operator and a dequantized operator is inserted into a second input branch of the addition operator Add, and the quantized operator is inserted into an output location of the addition operator Add.

A quantized operator is an operator capable of performing a quantization operation. In a generative model, a quantization operation usually refers to: performing discretization processing on an input quantity, to adapt the input quantity to low-bit representation and storage, thereby reducing memory occupation and energy consumption of the model.

A dequantized operator is an operator capable of performing a dequantization operation. In a generative model, a dequantization operation usually refers to: restoring data having been subjected to a quantization operation to a high-precision floating-point number or integer. The dequantization operation is an inverse operation of a quantization operation, and can recover an information loss caused by quantization.

A quantized operator and a dequantized operator are sequentially inserted to form a fake quantization node. For details, refer to a dashed-line box shown in (1) of FIG. 1d.

In an implementation, for details of Conv+BN+ReLU, refer to (1) in FIG. le. Locations of consecutive Conv+BN+ReLU may be found first, and then at least one target location corresponding to Conv+BN+ReLU may be obtained. A location between the input quantity and Conv is the target location corresponding to Conv+BN+ReLU. For details, refer to (1) in FIG. 1e.

Subsequently, a corresponding operator combination may be inserted into each target location. Descriptions are continued by using the foregoing example: A quantized operator and a dequantized operator may be sequentially inserted between the input quantity and Conv. For details, refer to (1) in FIG. 1e. In addition to sequentially inserting the quantized operator and the dequantized operator between the input quantity and Conv, a quantized operator combination further needs to be added for the weight of Conv, i.e., a quantized operator and a dequantized operator need to be sequentially inserted, as shown in (1) in FIG. 1e.

For details of Conv+BN+Add, refer to (1) in FIG. 1f. Locations of consecutive Conv+BN+Add may be found first, and then at least one target location corresponding to Conv+BN+Add may be obtained. Target locations between an input quantity one and Add, between an input quantity two and Conv, and between Add and the output quantity are the target locations corresponding to Conv+BN+Add. For details, refer to (1) in FIG. 1f.

Subsequently, a corresponding operator combination may be inserted into each target location. Descriptions are continued by using the foregoing example: A quantized operator and a dequantized operator may be sequentially inserted between the input quantity one and Add. For details, refer to (1) in FIG. 1f. A quantized operator and a dequantized operator may be sequentially inserted between the input quantity two and Conv. A quantized operator may be inserted between Add and the output quantity. In addition to adding the quantized operator and the dequantized operator, a quantized operator combination further needs to be added for the weight of Conv, i.e., a quantized operator and a dequantized operator need to be sequentially inserted, as shown in (1) in FIG. 1f.

In an implementation, an implementation process of performing a quantization operation by a quantized operator may be: implementing the quantization operation by symmetric quantization. In other words, a floating-point number interval with symmetric positive and negative number ranges is proportionally mapped to an integer interval [−a, a]. A value of a is a positive integer. In some embodiments, a may be 127.

Because distribution of floating-point numbers is usually asymmetric, truncation processing may be first performed on a distribution range of the floating-point numbers. In other words, for a complete distribution range of the floating-point numbers, symmetric positive and negative areas in which the floating-point numbers are frequently distributed may be selected for value truncation.

After the distribution range of the floating-point numbers is truncated, a mapping relationship between the floating-point numbers and integers may be established by using a given scale factor (scale) and an offset (zero_point):

$$x q = round ( x / scale + zero\_point )$$

where x is a floating-point number, xq is an integer mapped to the floating-point number, and round() refers to a round-down operation.

In the foregoing implementation, the scale factor may be calculated based on a distribution range [−cmax, cmax] of the floating-point numbers and the integer interval [−a, a]. The distribution range [−cmax, cmax] of the floating-point numbers may be obtained by operation personnel based on observation. In other words, operation personnel may select, via observation, the symmetric positive and negative areas in which the floating-point numbers are frequently distributed for value truncation. [−a, a] may be a preset fixed value. On the premise that ″ is a positive integer, a specific value range of a is not to be construed as a limitation to the present disclosure.

In the embodiments of the present disclosure, in addition to the foregoing process, the quantization operation may also be implemented using various other methods, including a moving average method, a histogram statistics method, and the like. The implementation process of implementing the quantization operation is also not to be construed as a limitation to the present disclosure.

In the foregoing implementation, after at least one target location corresponding to each target operator is found, a corresponding quantized operator combination may be inserted into each of the at least one target location, thereby implementing quantization processing for the target operator, simplifying the model structure simplification or changing the value type, and reducing the operational time of the model.

In one embodiment, the operation of “inserting a quantized operator combination into a target location” may include operation A1 and operation A2 as follows.

Operation A1: Obtain a value type of an input quantity corresponding to the target location.

A value type is one of the most basic and commonly used data types in computer programming, and is used for storing and operating various numeric data, such as an integer, a floating-point number, and a complex number.

Operation A2: Determine a corresponding quantized operator combination based on the value type of the input quantity.

In the foregoing implementation, a quantized operator combination inserted into a target location may be determined based on the value type of the input quantity corresponding to the target location, thereby achieving a unified value type of the trained model.

In one embodiment, operation A2 may include operation A21 and operation A22 as follows.

Operation A21: If the value type of the input quantity is a floating-point number, the corresponding quantized operator combination is determined to include a quantized operator and a dequantized operator.

For example, the floating-point number may be a 32-bit floating-point number. If the value type of the input quantity is a floating-point number, the input quantity of the value type of the floating-point number may be sequentially subjected to a quantized operator and a dequantized operator, so that quantization operation processing and dequantization operation processing are sequentially performed on the input quantity of the value type of the floating- point number. In this way, a value type of an obtained result is still a floating-point number.

Operation A22: If the value type of the input quantity is an integer, the corresponding quantized operator combination is determined to be a dequantization operator.

For example, the integer may be an 8-bit integer. If the value type of the input quantity is an integer, the input quantity of the integer type may be subjected to a dequantized operator, so that dequantization operation processing is performed on the input quantity of the integer type. In this way, a value type of an obtained result becomes a floating-point number.

In the foregoing implementation, regardless of whether the input quantity is of a floating-point number type or of an integer type, the value type of an output result can be adjusted to the floating-point number type by introducing a corresponding quantized operator combination, providing a basis for subsequent operations on the model, and further improving the operational speed of the model.

In one embodiment, operation 130 may include: performing the quantization processing on the target operator by using the preset quantization policy to obtain the to-be-trained generative model, when a model structure to which the target operator belongs is not included in a target structure list.

Correspondingly, the method according to the embodiments of the present disclosure may further include: maintaining the target operator unchanged, when the model structure to which the target operator belongs is included in the target structure list.

The target structure list is a structure whitelist set by operation personnel based on work experience. In some embodiments, the model structure in the target structure list may be a model structure whose output data precision needs to be maintained.

In the foregoing implementation, if the model structure to which the target operator belongs is in the target structure list, the target operator may still be maintained unchanged, i.e., the target operator is not quantized, even if the target operator satisfies the preset quantization policy.

By the foregoing processing process, the target operator can be maintained unchanged in the model structure whose data precision needs to be maintained, i.e., no operator adjustment is performed. For example, the quantization processing may not be performed in last several layers of the model. Referring to FIG. 1g, operator adjustment processing may not be performed on Conv encircled in solid-line boxes shown in FIG. 1g. By the foregoing process, the output precision and the operational speed of the generative model can both be ensured to some extent.

Operation 140: Train the generative model by using a training input object (e.g., training input data) to obtain a trained generative model.

In one embodiment, operation 140 may include operation 141 to operation 144 as follows.

Operation 141: Perform sampling processing on the training input object through the to-be-trained generative model, to obtain a random vector.

Operation 142: Perform generation processing on the random vector through the to-be-trained generative model, to obtain a newly-generated object (e.g., a target object).

Operation 143: Calculate a loss value based on the newly-generated object and the training input object.

For ease of description, an example in which the to-be-trained generative model is a generative adversarial network (GAN) is used for description. The GAN includes two neural networks: a generator and a discriminator.

Correspondingly, a loss function of the GAN mainly includes two parts: a loss function of the generator and a loss function of the discriminator.

### (1) Loss Function of the Generator

A goal of the generator is to generate samples as realistic as possible, and the loss function of the generator is expressed as Formula (1):

$$L\_G = - log ( D ( G ( z ) ) ) ; \qquad ( 1 )$$

where z is noise obtained via sampling from prior distribution, G represents the generator, and D represents the discriminator.

### (2) Loss Function of the Discriminator

A goal of the discriminator is to determine whether input data is real data or generated data, and the loss function of the discriminator may include two parts respectively expressed as Formula (2) and Formula (3):

$$L\_D \_real = - log ( D ( x ) ) ; \qquad ( 2 )$$

$$and$$

$$L\_D \_fake = - log ( 1 - D ( G ( z ) ) ; \qquad ( 3 )$$

where x is real data, G represents the generator, D represents the discriminator, and z is noise obtained via sampling from the prior distribution. L_D_real represents a loss function of the discriminator when determining real data as real data, and L_D_fake represents a loss function of the discriminator when determining generated data as real data.

Therefore, the loss function of the discriminator is expressed as Formula (4):

$$L\_D = L\_D \_real + L\_D \_fake ; \qquad ( 4 )$$

A final goal of the discriminator is to maximize a discrimination probability of real data and minimize a discrimination probability of generated data.

In conclusion, an overall loss function of the GAN is expressed as Formula (5):

$$L = L\_D + L\_G . \qquad ( 5 )$$

In each iterative process, an operation result of the loss function is calculated by using a specified parameter, so that a loss value corresponding to the iterative process may be obtained.

Operation 144: Determine, when the loss value satisfies a goal requirement, that training of the to-be-trained generative model is completed, to obtain the trained generative model.

The goal requirement is a preset requirement. In an implementation, for a plurality of loss values obtained in a plurality of training processes, if the plurality of loss values converge, it is determined that the loss value satisfies the goal requirement. In this case, it is determined that training of the to-be-trained generative model is completed, thus obtaining the trained generative model.

In the foregoing implementation, an initial generative model having been subjected to operator adjustment may be obtained first, and then the model is trained based on the foregoing operation 141 to operation 144, to obtain the trained generative model. After the initial generative model has been subjected to operator adjustment, the operational speed of the model is increased, and the operational time of the model is shortened. Through the training of the initial generative model having been subjected to operator adjustment, both the accuracy of the output result of the model and the operational speed of the model can be improved.

In some embodiments, the quantized operator combination includes a quantized operator and a dequantized operator. Correspondingly, the method according to the embodiments of the present disclosure may further include operation 150 as follows.

Operation 150: Obtain a target generative model based on the trained generative model obtained after deleting the dequantized operator.

The target generative model may support a native TorchScript deployment mode. TorchScript is a function in a PyTorch framework, and can convert a trained PyTorch model into a serialized and reusable format, for use in other environments such as C++, Java, JavaScript, or other programming languages.

In some embodiments, the trained generative model may be adjusted by deleting the dequantized operator, to obtain the target generative model.

In one embodiment, operation 150 may include:
if the trained generative model includes a convolution operator and an output location of the convolution operator is not connected to a batch normalization operator, deleting a dequantized operator between an input quantity and the convolution operator, deleting a quantized operator at the output location of the convolution operator, and expressing a weight of the convolution operator as an integer type.

Descriptions are continued by using the foregoing example.

Referring to (2) in FIG. 1d, (2) in FIG. 1d may be obtained from (1) in FIG. 1d by operator simplification processing. Compared with the model structure shown in (1) in FIG. 1d, in the model structure shown in (2) in FIG. 1d, the dequantized operator between the input quantity and the convolution operator is deleted, the quantized operator at the output location of the convolution operator is deleted, and the weight of the convolution operator is expressed as an integer type. In the foregoing implementation, not only the model structure is simplified, but also the computational load is reduced by adjusting an input quantity and an output quantity of the Conv shown in (2) in FIG. 1d from an original floating-point number to an integer.

In another embodiment, operation 150 may include:
if the trained generative model includes a combination of a convolution operator, a batch normalization operator, and an activation function, deleting a dequantized operator between an input quantity and the convolution operator, expressing a weight of the convolution operator as an integer type, and fusing the combination of the convolution operator, the batch normalization operator, and the activation function into a new convolution operator.

Referring to (2) in FIG. 1e, (2) in FIG. le may be obtained from (1) in FIG. 1e by operator fusion processing. Compared with the model structure shown in (1) in FIG. 1e, in the model structure shown in (2) in FIG. 1e, the dequantized operator between the input quantity and the convolution operator is deleted, the weight of the convolution operator is expressed as an integer type, and the combination of the convolution operator, the batch normalization operator, and the activation function is further fused into a new convolution operator. In the foregoing implementation, not only the model structure is simplified, but also the computational load is reduced by adjusting an input quantity and an output quantity of the Conv shown in (2) in FIG. 1e from an original floating-point number to an integer.

In still another embodiment, operation 150 may include:
if the trained generative model includes a combination of a convolution operator, a batch normalization operator, and an addition operator, deleting a dequantized operator between a first input quantity and the addition operator, deleting a dequantized operator between a second input quantity and the convolution operator, deleting a quantized operator at an output location of the addition operator, expressing the weight of the convolution operator as an integer type, and fusing the combination of the convolution operator, the batch normalization operator, and the addition operator into a new convolution operator.

Referring to (2) in FIG. 1f, (2) in FIG. If may be obtained from (1) in FIG. 1f by operator fusion processing. Compared with the model structure shown in (1) in FIG. 1f, in the model structure shown in (2) in FIG. 1f, the dequantized operator between the input quantity one and the addition operator is deleted, the dequantized operator between the input quantity two and the convolution operator is deleted, the quantized operator at the output location of the addition operator is deleted, the weight of the convolution operator is expressed as an integer type, and the combination of the convolution operator, the batch normalization operator, and the addition operator is fused into a new convolution operator. In the foregoing implementation, not only the model structure is simplified, but also the computational load is reduced by adjusting an input quantity and an output quantity of the Conv shown in (2) in FIG. If from an original floating- point number to an integer.

After the target generative model is obtained in operation 150, export processing may be performed on the target generative model. An export processing process is as follows:
saving the target generative model as a CheckPoint format file;
defining a quantization network, where a network format of the quantization network is the same as that of the target generative model;
loading the saved CheckPoint format file; and
exporting the target generative model.

In one embodiment, after operation 150, the method according to the

embodiments of the present disclosure may further include operation 160 as follows.

Operation 160: Perform processing on an input object through the target generative model, to generate new object data.

The input object is data that can be generated by a generative model, for example, image, text, or audio.

In the foregoing implementation, not only the model structure of the target generative model is simplified, but also the value types of the input quantity and the output quantity are adjusted, so that operation efficiency of the target generative model can be improved as much as possible.

In the data processing method provided in the embodiments of the present disclosure, an initial generative model may be first obtained, and then a target operator is searched for in the initial generative model. After the target operator is found, quantization processing may be performed on the target operator based on a category of the target operator by using a preset quantization policy, to obtain a quantized initial generative model, which is defined quantized initial generative model as the to-be-trained generative model. Subsequently, the to-be-trained generative model may be trained by using a training input object, to obtain a trained generative model. In the embodiments of the present disclosure, the target operator is one operator or a combination of a plurality of operators arranged in a set order. Therefore, the initial generative model may be first obtained, and the target operator is searched for in the initial generative model. Then, the quantization processing is performed on the target operator based on a preset quantization policy corresponding to the category of the target operator, to obtain a quantized initial generative model. Subsequently, the quantized initial generative model is trained, to obtain a trained generative model. By searching and performing quantization processing on the target operator, the model structure of the initial generative model can be simplified, so that the training efficiency of the model can be improved. In addition, the processing operations of searching for a preset target operator and performing quantization processing on the target operator based on a corresponding preset quantization policy can be used for training of the generative model in batches.

The embodiments of the present disclosure can alleviate the problem of time-consuming and inefficient generative model training in the related art.

A further detailed description will be given below according to the method described in the foregoing embodiments.

In this embodiment, the method in the embodiments of the present disclosure is described in detail by using an example in which the generative model is a GAN and the input object is an image.

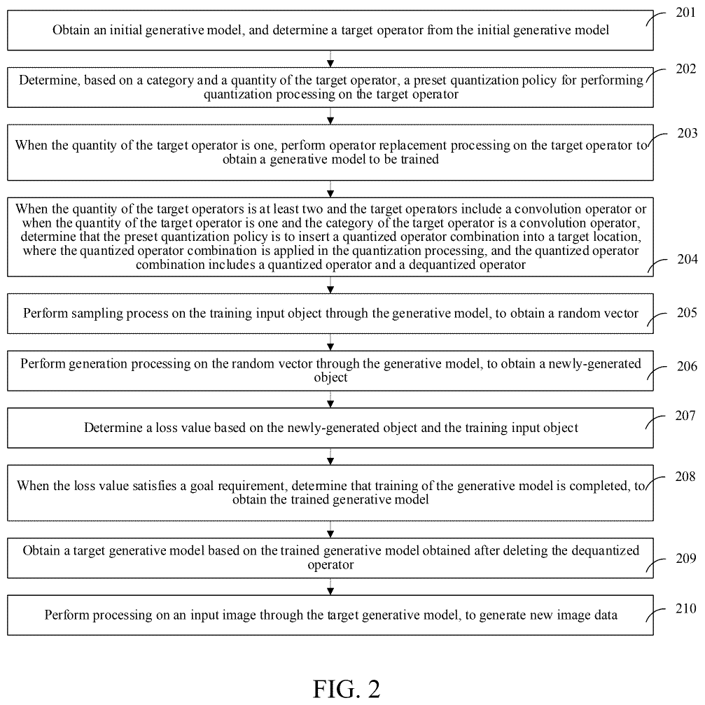

As shown in FIG. 2, an implementation process of the data processing method provided in the embodiments of the present disclosure is as follows.

Operation 201: Obtain an initial generative model, and determine a target operator to be quantized from the initial generative model.

Operation 202: Determine, based on a category and a quantity of the target operator, a preset quantization policy for performing quantization processing on the target operator.

Operation 203: When the quantity of the target operator is one, perform operator replacement processing on the target operator, to obtain a generative model to be trained.

Operation 204: When the quantity of the target operators is at least two and the target operators include a convolution operator or when the quantity of the target operator is one and the category of the target operator is a convolution operator, determine that the preset quantization policy is to insert a quantized operator combination into a target location, where the quantized operator combination is applied in the quantization processing, and the quantized operator combination includes a quantized operator and a dequantized operator.

In some embodiments, the foregoing operation 203 and operation 204 may both be implemented when a model structure to which a target operator belongs is not included in a target structure list. The target operator is maintained unchanged, when the model structure to which the target operator belongs is included in the target structure list.

In some embodiments, operation 204 may specifically include: when the quantity of the target operator is one and the category of the target operator is a convolution operator, inserting a quantized operator combination into a location between an input quantity and the convolution operator; and adding, to the initial generative model, a quantized operator combination configured to quantize a weight of the convolution operator, and obtaining the to-be-trained generative model when an output location of the convolution operator is connected to a batch normalization operator.

In one embodiment, the method according to the embodiments of the present disclosure may further include: inserting the quantized operator into the output location of the convolution operator to obtain the to-be-trained generative model, when the output location of the convolution operator is not connected to a batch normalization operator.

In one embodiment, the method according to the embodiments of the present disclosure may further include: inserting the quantized operator into the output location of the convolution operator, when the target operator is the convolution operator.

In some embodiments, operation 204 may specifically include: when the quantity of the target operators is at least two and the target operators include a convolution operator, inserting a quantized operator combination into a location between an input quantity and the convolution operator; adding, to the initial generative model, a quantized operator combination configured to quantize a weight of the convolution operator; and obtaining the to-be-trained generative model, when the target operators include a batch normalization operator and an activation function that are sequentially connected to an output location of the convolution operator.

In still another embodiment, the method according to the embodiments of the present disclosure may further include: when the quantity of the target operators is at least two, the target operators include a convolution operator, the target operators include a batch normalization operator that is sequentially connected to the output location of the convolution operator, and the batch normalization operator is further connected to a first input branch of the addition operator, skipping quantization on an output of the convolution operator, inserting the quantized operator combination into a second input branch of the addition operator, and inserting the quantized operator into an output location of the addition operator.

Operation 205: Perform sampling process on the training input object through the to-be-trained generative model, to obtain a random vector.

Operation 206: Perform generation processing on the random vector through the to-be-trained generative model, to obtain a newly-generated object.

Operation 207: Determine a loss value based on the newly-generated object and the training input object.

Operation 208: Determine, when the loss value satisfies a goal requirement, that training of the to-be-trained generative model is completed, to obtain the trained generative model.

Operation 209: Obtain a target generative model based on the trained generative model obtained after deleting the dequantized operator.

Operation 210: Perform processing on an input image through the target generative model, to generate new image data.

A process of performing operation 201 to operation 210 has been described above, so reference may be made to the foregoing description for the process of performing operation 201 to operation 210.

In the data processing method provided in the embodiments of the present disclosure, an initial generative model may be first obtained, and then a target operator to be quantized is determined in the initial generative model. Quantization processing is performed on the target operator based on a category and a quantity of the target operator by using a preset quantization policy, to obtain a quantized initial generative model, which is defined quantized initial generative model as a to-be-trained generative model. Subsequently, the to-be-trained generative model may be trained by using a training input object, to obtain a trained generative model. In the embodiments of the present disclosure, the target operator is one operator or a combination of a plurality of operators arranged in a set order. Therefore, the initial generative model may be first obtained, and the target operator is searched for in the initial generative model. Then, the quantization processing is performed on the target operator based on a preset quantization policy corresponding to the category of the target operator, to obtain a quantized initial generative model. Subsequently, the quantized initial generative model is trained, to obtain a trained generative model. By searching and performing quantization processing on the target operator, the model structure of the initial generative model can be simplified, so that the training efficiency of the model can be improved. In addition, the processing operations of searching for a preset target operator and performing quantization processing on the target operator based on a corresponding preset quantization policy can be used for training of the generative model in batches.

The embodiments of the present disclosure can alleviate the problem of time-consuming and inefficient generative model training in the related art.

To better implement the foregoing method, the embodiments of the present disclosure further provide a data processing apparatus. The data processing apparatus may be integrated in an electronic device. The electronic device may be a device such as a terminal or a server. The terminal may be a device such as a mobile phone, a tablet computer, a smart Bluetooth device, a notebook computer, or a personal computer (PC). The server may be a single server, or may be a server cluster including a plurality of servers. For example, in this embodiment, the method in the embodiments of the present disclosure is described by using an example in which the data processing apparatus is integrated in an electronic device which is a terminal.

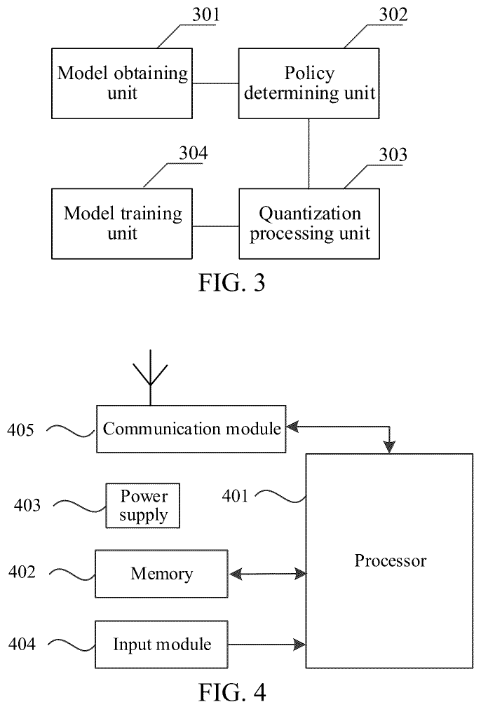

For example, as shown in FIG. 3, the data processing apparatus may include:
a model obtaining unit 301, configured to obtain an initial generative model, and determine a target operator to be quantized from the initial generative model;
a policy determining unit 302, configured to determine, based on a category and a quantity of the target operator, a preset quantization policy for performing quantization processing on the target operator;
a quantization processing unit 303, configured to perform the quantization processing on the target operator by using the preset quantization policy to obtain a generative model to be trained; and
a model training unit 304, configured to train the generative model by using a training input object to obtain a trained generative model.

In an implementation, the policy determining unit 302 is further configured to determine, when the quantity of the target operator is one, that the preset quantization policy is to perform operator replacement processing on the target operator.

Correspondingly, the quantization processing unit 303 is further configured to obtain an operator combination of an input quantity direction of the target operator, and determine a quantized operator; and replace the operator combination by using the quantized operator, to obtain the to-be-trained generative model.

In an implementation, the policy determining unit 302 is further configured to determine, when the quantity of the target operators is at least two and the target operators include a convolution operator or when the quantity of the target operator is one and the category of the target operator is a convolution operator, that the preset quantization policy is to insert a quantized operator combination into a target location, where the quantized operator combination is applied in the quantization processing, and the quantized operator combination includes a quantized operator and a dequantized operator.

In an implementation, the quantization processing unit 303 is further configured to: when the quantity of the target operator is one and the category of the target operator is a convolution operator, insert a quantized operator combination into a location between an input quantity and the convolution operator; and add, to the initial generative model, a quantized operator combination configured to quantize a weight of the convolution operator, and obtaining the to-be-trained generative model when an output location of the convolution operator is connected to a batch normalization operator.

In an implementation, the apparatus further includes: a quantized operator insertion unit, configured to insert the quantized operator into the output location of the convolution operator to obtain the to-be-trained generative model, when the output location of the convolution operator is not connected to a batch normalization operator.

In an implementation, the quantization processing unit 303 is further configured to insert a quantized operator combination into a location between an input quantity and the convolution operator, when the quantity of the target operators is at least two and the target operators include a convolution operator; add, to the initial generative model, a quantized operator combination configured to quantize a weight of the convolution operator; and obtain the to-be-trained generative model, when the target operators include a batch normalization operator and an activation function that are sequentially connected to an output location of the convolution operator.

In an implementation, the apparatus further includes: a combination unit, configured to: when the quantity of the target operators is at least two, the target operators include a convolution operator, the target operators include a batch normalization operator that is sequentially connected to the output location of the convolution operator, and the batch normalization operator is further connected to a first input branch of the addition operator, skip quantization on an output of the convolution operator, insert the quantized operator combination into a second input branch of the addition operator, and insert the quantized operator into an output location of the addition operator.

In an implementation, the model training unit 304 includes:
a sampling processing subunit, configured to perform sampling processing on the training input object through the to-be-trained generative model, to obtain a random vector;
a generation processing subunit, configured to perform generation processing on the random vector through the to-be-trained generative model, to obtain a newly-generated object;
a loss value calculation subunit, configured to calculate a loss value based on the newly-generated object and the training input object; and
a model training subunit, configured to determine, when the loss value satisfies a goal requirement, that training of the to-be-trained generative model is completed, to obtain the trained generative model.

In an implementation, the quantization processing unit 303 is further configured to perform the quantization processing on the target operator based on the category of the target operator, to obtain a quantized initial generative model, when a model structure to which the target operator belongs is not included in a target structure list.

The apparatus further includes:
a combination maintaining unit, configured to maintain the target operator
unchanged, when the model structure to which the target operator belongs is included in the target structure list.

In an implementation, the quantized operator combination includes a quantized operator and a dequantized operator. Correspondingly, the apparatus further includes:
an operator deletion unit, configured to obtain a target generative model based on the trained generative model obtained after deleting the dequantized operator.

The term unit (and other similar terms such as subunit, module, submodule, etc.) in this disclosure may refer to a software unit, a hardware unit, or a combination thereof. A software unit (e.g., computer program) may be developed using a computer programming language. A hardware unit may be implemented using processing circuitry and/or memory. Each unit can be implemented using one or more processors (or processors and memory). Likewise, a processor (or processors and memory) can be used to implement one or more units. Moreover, the above units may be implemented as independent entities, or may be combined in different ways, or may be implemented as the same entity or a plurality of entities. For specific implementation of the above units, reference may be made to the above method embodiments, which are not described herein.

In the data processing method provided in the embodiments of the present disclosure, an initial generative model may be first obtained, and then a target operator is searched for in the initial generative model. After the target operator is found, quantization processing may be performed on the target operator based on a category of the target operator by using a preset quantization policy, to obtain a quantized initial generative model, which is defined quantized initial generative model as the to-be-trained generative model. Subsequently, the to-be-trained generative model may be trained by using a training input object, to obtain a trained generative model. In the embodiments of the present disclosure, the target operator is one operator or a combination of a plurality of operators arranged in a set order. Therefore, the initial generative model may be first obtained, and a target operator to be quantized is determined from the initial generative model; a preset quantization policy for performing quantization processing on the target operator is determined based on a category and a quantity of the target operator; quantization processing is performed on the target operator by using the preset quantization policy to obtain a generative model to be trained; and the to-be-trained generative model is trained by using a training input object to obtain a trained generative model. By searching and performing quantization processing on the target operator, the model structure of the initial generative model can be simplified, so that the training efficiency of the model can be improved. In addition, the processing operations of searching for a preset target operator and performing quantization processing on the target operator based on a corresponding preset quantization policy can be used for training of the generative model in batches.

The embodiments of the present disclosure can alleviate the problem of time-consuming and inefficient generative model training in the related art.

The embodiments of the present disclosure further provide an electronic device. The electronic device may be a device such as a terminal or a server. The terminal may be a mobile phone, a tablet computer, a smart Bluetooth device, a notebook computer, a personal computer, or the like. The server may be a single server, a server cluster including a plurality of servers, or the like.

In some embodiments, the data processing apparatus may also be integrated in a plurality of electronic devices. For example, the data processing apparatus may be integrated in a plurality of servers, and the data processing method of the present disclosure is implemented by the plurality of servers.

In this embodiment, an example in which the electronic device in this embodiment is a server is used for description. FIG. 4 is a schematic structural diagram of an electronic device according to an embodiment of the present disclosure. As shown in FIG. 4, the electronic device may include a processor 401 including one or more processing cores, a memory 402 including one or more computer-readable storage media, a power supply 403, an input module 404, a communication module 405, and other components. The structure of the electronic device shown in FIG. 4 does not constitute a limit to the electronic device. The electronic device may include more or fewer components than those shown in the figure, some components may be combined, or different arrangements of components may be used.

The processor 401 is a control center of the electronic device, which is connected to various parts of the entire electronic device by various interfaces and lines, and is configured to run or execute a software program and/or module stored in the memory 402 and call data stored in the memory 402, to execute various functions of the electronic device and process data. In some embodiments, the processor 401 may include one or more processing units. In some embodiments, an application processor and a modem processor may be integrated in the processor 401. The application processor mainly processes an operating system, a user interface, an application, and the like, and the modem processor mainly processes wireless communication. The modem processor may not be integrated in the processor 401.

The memory 402 may be configured to store the software program and module. The processor 401 runs the software program and module stored in the memory 402 to execute various function applications and data processing. The memory 402 may mainly include a program storage area and a data storage area. The program storage area may store an operating system, an application required for at least one function (for example, a sound playback function and an image playback function), and the like. The data storage area may store data or the like created according to the use of the electronic device. In addition, the memory 402 may include a high-speed random access memory, and may further include a non-volatile memory, such as at least one disk storage device, a flash memory device, or other volatile solid-state storage device. Correspondingly, the memory 402 may further include a memory controller, to provide access to the memory 402 for the processor 401.

The electronic device further includes the power supply 403 for supplying power to the components. In some embodiments, the power supply 403 may be logically connected to the processor 401 through a power management system, thereby implementing functions such as charging, discharging, and power consumption management through the power management system. The power supply 403 may further include any component such as one or more direct current or alternating current power supplies, a recharging system, a power failure detection circuit, a power converter or inverter, and a power status indicator.

The electronic device may further include the input module 404. The input module 404 may be configured to receive input digit or character information and generate a keyboard, mouse, joystick, optical, or trackball signal input related to the user setting and function control.

The electronic device may further include a communication module 405. In some embodiments, the communication module 405 may include a wireless module. The electronic device may perform short-distance wireless transmission by using the wireless module of the communication module 405, to provide wireless broadband Internet access for a user. For example, the communication module 405 may be configured to help the user to receive and send e-mails, browse a web page, access streaming media, and the like.

Although not shown in the figure, the electronic device may further include a display unit and the like. Details will not be described herein again. Specifically, in this embodiment, the processor 401 of the electronic device may load executable files corresponding to processes of one or more application programs into the memory 402 based on instructions. The processor 401 runs the application programs stored in the memory 402, to implement various functions. The instructions include:
first obtaining an initial generative model, and determining a target operator to be quantized from the initial generative model; determining, based on a category and a quantity of the target operator, a preset quantization policy for performing quantization processing on the target operator; performing the quantization processing on the target operator by using the preset quantization policy to obtain a generative model to be trained; and training the generative model by using a training input object to obtain a trained generative model.

For specific implementations of the above operations, reference may be made to the above embodiments, and the details will not be described herein again.

A person of ordinary skill in the art may understand that all or some operations of various methods in the foregoing embodiments may be implemented through instructions, or may be implemented by instructions controlling relevant hardware, and the instructions may be stored in a computer-readable storage medium and loaded and executed by a processor.

Therefore, the embodiments of the present disclosure further provide a computer-readable storage medium having a plurality of instructions stored therein. The instructions can be loaded by a processor, to perform the operations in any one of the data processing methods provided in the embodiments of the present disclosure. For example, the instructions may perform the following operations:
obtaining an initial generative model; searching for a target operator from the initial generative model; performing quantization processing on the target operator based on a category of the target operator by using a preset quantization policy, to obtain a quantized initial generative model, and record the quantized initial generative model as a to-be-trained generative model; and training the generative model by using a training input object to obtain a trained generative model.

The storage medium may include: a read-only memory (ROM), a random access memory (RAM), a magnetic disk, an optical disc, or the like.

According to one aspect of the present disclosure, a computer program product or a computer program is provided. The computer program product or computer program includes computer instructions, and the computer instructions are stored in a computer-readable storage medium. A processor of a computer device reads the computer instructions from the computer-readable storage medium, and executes the computer instructions, to cause the computer device to perform the method provided in the various implementations provided in the foregoing embodiments.

Since the instructions stored in the computer-readable storage medium can perform the operations in any data processing method provided in the embodiments of the present disclosure, the beneficial effects that can be implemented by any data processing method provided in the embodiments of the present disclosure can be achieved. For details, reference may be made to the above embodiments, and the details will not be described herein again.

The data processing method and apparatus, the electronic device, and the computer-readable storage medium provided in the embodiments of the present disclosure have been described in detail above. The principles and implementations of the present disclosure are described by using specific examples, and the descriptions of the embodiments are only used for helping understand the method of the present disclosure and the core idea of the present disclosure. Meanwhile, a person skilled in the art may make modifications to the specific implementations and application range according to the idea of the present disclosure. In conclusion, the content of this specification is not to be construed as a limitation on the present disclosure.

What is claimed is:

1. A data processing method, applied to an electronic device, the method comprising:
obtaining an initial generative model, and determining a target operator to be quantized from the initial generative model;
determining, based on a category and a quantity of the target operator, a preset quantization policy for performing quantization processing on the target operator;
performing the quantization processing on the target operator by using the preset quantization policy to obtain a generative model to be trained; and
training the generative model by using a training input object to obtain a trained generative model.

2. The method according to claim 1, wherein the determining, based on a category and a quantity of the target operator, a preset quantization policy for performing quantization processing on the target operator comprises:
determining, in response to the quantity of the target operator being one, that the preset quantization policy is to perform operator replacement processing on the target operator; and
the performing the quantization processing on the target operator by using the preset quantization policy to obtain a generative model to be trained comprises:
obtaining an operator combination of an input quantity direction of the target operator, and determining a quantized operator; and
replacing the operator combination by using the quantized operator, to obtain the generative model to be trained.

3. The method according to claim 1, wherein the determining, based on a category and a quantity of the target operator, a preset quantization policy for performing quantization processing on the target operator comprises:
determining, in response to the quantity of the target operators being at least two and the target operators comprising a convolution operator or in response to the quantity of the target operator being one and the category of the target operator being a convolution operator, that the preset quantization policy is to insert a quantized operator combination into a target location, wherein the quantized operator combination is applied in the quantization processing, and the quantized operator combination comprises a quantized operator and a dequantized operator.

4. The method according to claim 3, wherein the performing the quantization processing on the target operator by using the preset quantization policy to obtain a generative model to be trained comprises:
in response to the quantity of the target operator being one and the category of the target operator being the convolution operator, inserting the quantized operator combination into a location between an input quantity and the convolution operator; and
adding, to the initial generative model, a quantized operator combination configured to quantize a weight of the convolution operator, and obtaining the generative model to be trained in response to an output location of the convolution operator being connected to a batch normalization operator.

5. The method according to claim 4, further comprising:
inserting the quantized operator into the output location of the convolution operator to obtain the generative model to be trained, in response to the output location of the convolution operator not being connected to the batch normalization operator.

6. The method according to claim 3, wherein the performing the quantization processing on the target operator by using the preset quantization policy to obtain a generative model to be trained comprises:
in response to the quantity of the target operators being at least two and the target operators comprising the convolution operator, inserting the quantized operator combination into a location between an input quantity and the convolution operator;
adding, to the initial generative model, a quantized operator combination configured to quantize a weight of the convolution operator; and
obtaining the generative model to be trained, in response to the target operators comprising a batch normalization operator and an activation function that are sequentially connected to an output location of the convolution operator.

7. The method according to claim 6, further comprising:
in response to: the quantity of the target operators being at least two, the target operators comprising the convolution operator, the target operators comprising the batch normalization operator that is sequentially connected to the output location of the convolution operator, and the batch normalization operator being further connected to a first input branch of the addition operator, skipping quantization on an output of the convolution operator, inserting the quantized operator combination into a second input branch of the addition operator, and inserting the quantized operator into an output location of the addition operator.

8. The method according to claim 1, wherein the training the generative model by using a training input object to obtain a trained generative model comprises:
performing sampling processing on the training input object through the generative model to be trained, to obtain a random vector;
performing generation processing on the random vector through the generative model to be trained, to obtain a target object;
determining a loss value based on the target object and the training input object; and
determining, in response to the loss value satisfying a goal requirement, that training of the generative model is completed, to obtain the trained generative model.

9. The method according to claim 1, wherein the performing the quantization processing on the target operator by using the preset quantization policy to obtain a generative model to be trained comprises:
performing the quantization processing on the target operator by using the preset quantization policy to obtain the generative model to be trained, in response to a model structure to which the target operator belongs being not comprised in a target structure list; and
the method further comprises:
maintaining the target operator unchanged, in response to the model structure to which the target operator belongs being comprised in the target structure list.

10. The method according to claim 1, wherein the quantized operator combination comprises a quantized operator and a dequantized operator; and
the method further comprises:
obtaining a target generative model based on the trained generative model obtained after deleting the dequantized operator.

11. A data processing apparatus, comprising:
a processor and a memory, the memory storing a plurality of instructions, and the processor loading the instructions from the memory, to execute operations comprising:
obtaining an initial generative model, and determining a target operator to be quantized from the initial generative model;
determining, based on a category and a quantity of the target operator, a preset quantization policy for performing quantization processing on the target operator;
performing the quantization processing on the target operator by using the preset quantization policy to obtain a generative model to be trained; and
training the generative model by using a training input object to obtain a trained generative model.

12. The apparatus according to claim 11, wherein the determining, based on a category and a quantity of the target operator, a preset quantization policy for performing quantization processing on the target operator comprises:
determining, in response to the quantity of the target operator being one, that the preset quantization policy is to perform operator replacement processing on the target operator; and
the performing the quantization processing on the target operator by using the preset quantization policy to obtain a generative model to be trained comprises:
obtaining an operator combination of an input quantity direction of the target operator, and determining a quantized operator; and
replacing the operator combination by using the quantized operator, to obtain the generative model to be trained.

13. The apparatus according to claim 11, wherein the determining, based on a category and a quantity of the target operator, a preset quantization policy for performing quantization processing on the target operator comprises:
determining, in response to the quantity of the target operators being at least two and the target operators comprising a convolution operator or in response to the quantity of the target operator being one and the category of the target operator being a convolution operator, that the preset quantization policy is to insert a quantized operator combination into a target location, wherein the quantized operator combination is applied in the quantization processing, and the quantized operator combination comprises a quantized operator and a dequantized operator.

14. The apparatus according to claim 13, wherein the performing the quantization processing on the target operator by using the preset quantization policy to obtain a generative model to be trained comprises:
in response to the quantity of the target operator being one and the category of the target operator being the convolution operator, inserting the quantized operator combination into a location between an input quantity and the convolution operator; and
adding, to the initial generative model, a quantized operator combination configured to quantize a weight of the convolution operator, and obtaining the generative model to be trained in response to an output location of the convolution operator being connected to a batch normalization operator.

15. The apparatus according to claim 14, wherein the processor is further configured to perform:
inserting the quantized operator into the output location of the convolution operator to obtain the generative model to be trained, in response to the output location of the convolution operator not being connected to the batch normalization operator.

16. The apparatus according to claim 13, wherein the performing the quantization processing on the target operator by using the preset quantization policy to obtain a generative model to be trained comprises:
in response to the quantity of the target operators being at least two and the target operators comprising the convolution operator, inserting the quantized operator combination into a location between an input quantity and the convolution operator;
adding, to the initial generative model, a quantized operator combination configured to quantize a weight of the convolution operator; and
obtaining the generative model to be trained, in response to the target operators comprising a batch normalization operator and an activation function that are sequentially connected to an output location of the convolution operator.

17. The apparatus according to claim 16, wherein the processor is further configured to perform:
in response to: the quantity of the target operators being at least two, the target operators comprising the convolution operator, the target operators comprising the batch normalization operator that is sequentially connected to the output location of the convolution operator, and the batch normalization operator being further connected to a first input branch of the addition operator, skipping quantization on an output of the convolution operator, inserting the quantized operator combination into a second input branch of the addition operator, and inserting the quantized operator into an output location of the addition operator.

18. The apparatus according to claim 11, wherein the training the generative model by using a training input object to obtain a trained generative model comprises:
performing sampling processing on the training input object through the generative model to be trained, to obtain a random vector;
performing generation processing on the random vector through the generative model to be trained, to obtain a target object;
determining a loss value based on the target object and the training input object; and
determining, in response to the loss value satisfying a goal requirement, that training of the generative model is completed, to obtain the trained generative model.

19. The apparatus according to claim 11, wherein the performing the quantization processing on the target operator by using the preset quantization policy to obtain a generative model to be trained comprises:
performing the quantization processing on the target operator by using the preset quantization policy to obtain the generative model to be trained, in response to a model structure to which the target operator belongs being not comprised in a target structure list; and
the processor is further configured to perform:
maintaining the target operator unchanged, in response to the model structure to which the target operator belongs being comprised in the target structure list.

20. A non-transitory computer-readable storage medium, having a plurality of instructions stored therein, the instructions being loaded by a processor to execute operations comprising:
obtaining an initial generative model, and determining a target operator to be quantized from the initial generative model;
determining, based on a category and a quantity of the target operator, a preset quantization policy for performing quantization processing on the target operator;
performing the quantization processing on the target operator by using the preset quantization policy to obtain a generative model to be trained; and
training the generative model by using a training input object to obtain a trained generative model.
